(19) United States
(12) Patent Application Publication
(10) Pub. No.: US 2019/0060160 A1
(43) Pub. Date: Feb. 28, 2019

(54) MASSAGE ROLLER

(71) Applicant: ProSource Discounts, Inc., Chatsworth, CA (US)

(72) Inventors: Anatoly Krichevsky, West Hills, CA (US); Igor Finkelshteyn, Woodland Hills, CA (US)

(21) Appl. No.: 16/112,576

(22) Filed: Aug. 24, 2018

Related U.S. Application Data
(60) Provisional application No. 62/550,386, filed on Aug. 25, 2017.

(51) Int. Cl. A61H 15/00

(52) U.S. Cl. CPC A61H 15/0092; A61H 2201/169

(57) ABSTRACT

The massage roller includes a generally cylindrically-shaped core having a central axis, an overlay formed around an outer surface of the cylindrically-shaped core and having a size and shape to facilitate rolling engagement with myofascial tissue, and at least one cavity formed from the outer surface of the cylindrically-shaped core that reduces a mass of the massage roller while the massage roller simultaneously maintains substantially the same structural rigidity for rolling engagement with myofascial tissue.

### BACKGROUND OF THE INVENTION

The present invention generally relates to a massage roller. More specifically, the present invention relates to a massage roller that includes a reduced weight yet structurally reinforced core having an overlay thereover designed for myofascial massage.

Rollers may be used primarily to achieve myofascial release and may be associated with many health benefits including alleviating muscle tension or tightness, promoting musculoskeletal flexibility, improving blood circulation, relieving pressure on joints or bones, mitigating the occurrence and intensity of chronic headaches, and even aiding in gland function. Myofascial release is a type of massage therapy that applies gentle sustained movement and pressure to the fascia, which is connective tissue beneath the skin that surrounds, interpenetrates, and connects to every muscle, bone, nerve, artery, vein, and internal organ in the body, to release tight areas in the myofascial tissues throughout the body. Such massage techniques are designed to remove pressure from pain sensitive structures and free restrictions so that the body can move more effortlessly without pain, and to achieve the health benefits mentioned herein.

A variety of myofascial release techniques are known in the art, including manual and/or automated techniques. For example, manual techniques known in the art may be highly effective in achieving myofascial release, but such techniques are usually employed by professionals who may not be easily accessible (e.g., on a daily or regular basis) due to cost and/or convenience. Massage rollers, on the other hand, are generally widely available and relatively inexpensive products designed for personal use (e.g., at home or the gym) and may be cost effective alternative methods for achieving myofascial release. Massage rollers may also obviate accessibility issues associated with professional masseuses since the massage roller may be purchased once and transported to desired locations for use, such as at home or the gym. Certainly, one time massage roller purchases are relatively inexpensive in comparison to repeated professional massages, and may be used at any convenient time once acquired.

Massage rollers are beneficial in that they may be used to achieve myofascial release in many different locations of the body or fascia. The general technique for using a massage roller to accomplish myofacial release is to use the massage roller to apply a static or dynamic pressure at any location along the fascia where release is desired. For example, the user may first place the roller on the floor and then compress the body fascia against the massage roller to achieve the desired release. The massage roller may include one or more projections designed to extend into the soft tissue to provide a deeper massage of the fascia. The user may slowly move the massage roller along the fascia so the contact area between the roller and the body slowly changes. As the roller contacts locations of the body at or in close proximity to the location where release is desired, the pressure applied to those locations may achieve the desired myofascial release.

Massage roller core designs are limited for reasons due to weight and structural integrity. A basic design for a massage roller core may include a solid cylindrical body that generally fits within the overlay (or the overlay itself is formed thereover). This design may provide a generally cylindrical surface that facilitates rolling engagement between the fascia and the projections of the massage roller. Although, such rollers may be unnecessarily heavy given the solid core construction, even if the core is made from a generally lightweight material, since much of the internal material of the solid cylindrical core may not be necessary as long as the massage roller can maintain its shape (e.g., the overlay does not unnecessarily depress inwardly when compressed) during use. As such, massage rollers having a solid cylindrical core may be undesirably heavy and bulky.

Other massage rollers known in the art have a hollow core. Although, such hollow core massage rollers still require the use of a reinforced structural material such as a relatively thick PVC pipe or the like to provide the structural integrity needed to support the overlay disposed thereon (e.g., so the overlay does not undesirably compress during use). As such, even without a solid cylindrical core, such hollow core massage rollers may still be undesirably heavy given the need for the relatively compact and reinforced cylindrical material to which the overlay may attach. Using softer or less dense materials to support the overlay may not provide the required structural integrity (e.g., comparable to a massage roller having a solid cylindrical core), as the material supporting the overlay may be insufficiently thick to maintain the rigidity of the overlay such that the overlay may have a tendency to deflect inwardly during use. As a result, hollow core massage rollers generally either need denser and heavier reinforcement (such as a PVC style pipe) or are insufficiently reinforced such to attain the desired myofascial release due to a lack of structural integrity and support.

There exists, therefore, a significant need in the art for a massage roller that includes a core supportive of an overlay yet includes one or more channels, cutouts, or notches to reduce the material therein and ultimately the mass of the roller. Such channels, cutouts, and/or notches may be proximate a central axis of an otherwise cylindrical core and positioned at intervals and/or locations therein to maintain rollability and the structural integrity of the massage roller, while reducing weight and production cost. The present invention fulfills these needs and provides further related advantages.

### SUMMARY OF THE INVENTION

One embodiment of a massage roller disclosed herein includes a generally cylindrically-shaped core having a central axis, an overlay formed around an outer surface of the cylindrically-shaped core and having a size and shape to facilitate rolling engagement with myofascial tissue, and at least one cavity formed from the outer surface of the cylindrically-shaped core that reduces a mass of the massage roller while the massage roller simultaneously maintains substantially the same structural rigidity for rolling engagement with myofascial tissue.

The cavity may include a straight channel, a curved channel, a patterned channel, or a spiral channel; and/or the cavity may include a longitudinal channel generally parallel to the central axis and extending a length of the cylindrically-shaped core and having a rectangular shape, a semicircular shape, or a zig-zag shape; and/or the cavity may include at least one transverse channel formed generally perpendicular to the central axis; and/or the cavity may include a set of alternating partial axial channels positioned along a length of the cylindrically-shaped core with each of the set of alternating partial axial channels having a length relatively smaller than a length of the cylindrically-shaped core; and/or the cavity may include an edge notch formed from at least one end of the cylindrically-shaped core; and/or the cavity may include an oblong cutout, a rectangular cutout, or a triangular cutout. Of course, the cavity may include multiple cavities positioned relatively equidistantly or non-equidistantly relative to one another.

In the embodiments wherein the cavity includes the longitudinal channel, the massage roller core may include multiple longitudinal channels positioned approximately equidistantly from one another about a circumference of the cylindrically-shaped core. Additionally, at least one of the multiple longitudinal channels may be positioned perpendicular to and may intersect the at least one transverse channel. In this respect, the at least one transverse channel may include four linearly aligned transverse channels together circumscribing the central axis of the cylindrically-shaped core, thereby forming a rectangular-shaped cut-out. Additionally, the rectangular-shaped cut-out may have a width greater than 50% of the width of the cylindrically-shaped core such that the overlay is supported by the outer surface at opposite ends of the cylindrically-shaped core. Alternatively, the at least one transverse channel may include at least three linearly aligned transverse channels together circumscribing the central axis of the cylindrically-shaped core, thereby forming a polygonal-shaped cut-out. Here, the polygonal-shaped cut-out may include a triangular-shaped cut-out, a pentagonal-shaped cut-out, or a hexagonal-shaped cut-out.

In the embodiments wherein the cavity includes partial axial channels, at least two of the set of alternating partial axial channels may be in misalignment with one another and/or at least one of the alternating partial axial channels may intersect at least one transverse channel.

In embodiments wherein the cavity includes an edge notch, in some embodiments, the edge notch may be externally visible when the overlay is positioned over the outer surface of the cylindrically-shaped core. In alternative embodiments, the overlay may include an annular edge flap having a diameter relatively smaller than a major diameter of the cylindrically-shaped core so the annular edge flap is positioned to generally envelope the edge notch and lock the cylindrically-shaped core within the overlay. Here, the overlay may be made from an elastic material that permits temporary deformation of the annular edge flap to insert and/or remove the cylindrically-shaped core. Alternatively, each end of the cylindrically-shaped core may include a plurality of edge notches positioned at equidistant intervals relative to one another and either exposed or hidden therein by the annular edge flap.

In another embodiment as disclosed herein, the massage roller may include a generally cylindrically-shaped core having a central axis, an overlay formed around an outer surface of the cylindrically-shaped core and having a size and shape to facilitate rolling engagement with myofascial tissue, and at least three linearly aligned transverse channels formed from the outer surface of the cylindrically-shaped core and generally perpendicular to the central axis together circumscribing the central axis to form a polygonal-shaped cut-out that reduces a mass of the massage roller while the massage roller simultaneously maintains substantially the same structural rigidity for rolling engagement with myofascial tissue.

In one embodiment, the at least three linearly aligned transverse channels may include four substantially equal sized linearly aligned transverse channels together forming a rectangular-shaped cut-out having a width greater than 50% of the width of the cylindrically-shaped core. Alternatively, the polygonal-shaped cut-out may include other shapes, such as a triangular-shaped cut-out, a pentagonal-shaped cut-out, or a hexagonal-shaped cut-out.

These embodiments may also include one or more longitudinal channels positioned perpendicular to and intersecting at least one of the at least three linearly aligned transverse channels. Here, the longitudinal channel may extend a length of the cylindrically-shaped core. Also, the massage roller may include multiple cavities formed in the outer surface and positioned equidistantly or non-equidistantly relative to one another.

Additionally, the massage roller core may include a set of alternating partial axial channels formed into the outer surface of the cylindrically-shaped core and have a length relatively shorter than a length of the cylindrically-shaped core. Here, at least one of the alternating partial axial channels may intersect at least one of the at least three linearly aligned transverse channels. Also, at least two of the set of alternating partial axial channels may be in misalignment with one another and the outer surface may include at least one of an oblong cutout, a rectangular cutout, or a triangular cutout.

In another alternative embodiment, the massage roller may include a generally cylindrically-shaped core having a central axis, an overlay formed around an outer surface of the cylindrically-shaped core and having a size and shape to facilitate rolling engagement with myofascial tissue, at least one edge notch formed from at least one end of the cylindrically-shaped core to reduce a mass of the massage roller while the massage roller simultaneously maintains substantially the same structural rigidity for rolling engagement with myofascial tissue, and an annular edge flap having a diameter relatively smaller than a major diameter of the cylindrically-shaped core and being positioned to generally envelope the edge notch and lock the cylindrically-shaped core within the overlay. Here, the annular edge flap may be made from an elastic material permitting temporary deformation thereof to insert and/or remove the cylindrically-shaped core. Moreover, each end of the cylindrically-shaped core may include a plurality of edge notches positioned at equidistant intervals relative to one another.

In another aspect of these embodiments, the massage roller may include multiple cavities formed into the outer surface of the cylindrically-shaped core and positioned equidistantly or non-equidistantly relative to one another. The multiple cavities may include oblong cutouts, rectangular cutouts, or triangular cutouts. Additionally, the massage roller could also include a set of alternating partial axial channels positioned along a length of the cylindrically-shaped core. Here, each of the set of alternating partial axial channels may have a length relatively smaller than a length of the cylindrically-shaped core. Additionally, at least two of the set of alternating partial axial channels may be in misalignment with one another and at least one of the alternating partial axial channels may intersect at least one transverse channel formed into the outer surface of the cylindrically-shaped core.

In another alternative embodiment, the massage roller may include a generally cylindrically-shaped core having a central axis, an overlay formed around an outer surface of the cylindrically-shaped core and having a size and shape to facilitate rolling engagement with myofascial tissue, at least one transverse channel formed generally perpendicular to the central axis, at least one longitudinal channel generally parallel to the central axis and extending a length of the cylindrically-shaped core and intersecting the at least one transverse channel, a set of alternating partial axial channels positioned along a length of the cylindrically-shaped core, each having a length relatively shorter than a length of the cylindrically-shaped core, and an edge notch formed from at least one end of the cylindrically-shaped core. As such, each of the at least one transverse channel, the at least one longitudinal channel, the set of alternating partial axial channels, and the edge notch may cooperate together to reduce a mass of the massage roller while the massage roller simultaneously maintains substantially the same structural rigidity for rolling engagement with myofascial tissue.

Moreover, the longitudinal channel may include multiple longitudinal channels positioned approximately equidistantly from one another about a circumference of the cylindrically-shaped core. Here, the multiple longitudinal channels may include straight channels, curved channels, patterned channels, spiral channels, rectangular channels, semicircular channels, or zig-zag channels. Alternatively, the at least one transverse channel may include at least three linearly aligned transverse channels together circumscribing the central axis of the cylindrically-shaped core, thereby forming a polygonal-shaped cut-out having a width greater than 50% of the width of the cylindrically-shaped core such that the overlay is supported by the outer surface at opposite ends of the cylindrically-shaped core.

The edge notch may be externally visible when the overlay is positioned over the outer surface of the cylindrically-shaped core. Alternatively, the overlay may be made from an elastic material permitting temporary deformation of an integral annular edge flap having a diameter relatively smaller than a major diameter of the cylindrically-shaped core so that the annular edge flap can be stretched from a normal use position generally enveloping the edge notch and locking the cylindrically-shaped core within the overlay to an open position permitting insertion and/or removal of the cylindrically-shaped core. Alternatively, each end of the cylindrically-shaped core may include a plurality of edge notches positioned at equidistant intervals relative to one another. In another aspect of the embodiments disclosed herein, the massage roller core may include a cavity that includes an oblong cutout, a rectangular cutout, or a triangular cutout.

In another embodiment of the massage roller as disclosed herein may include an overlay that may be wrapped on and/or removed from an interiorly located massage roller core. The massage roller core may include a generally cylindrically shape having a outer round or curved surface with one or more channels, cutouts, or notches formed therein. The channels, cutouts, or notches may generally be straight, curved, or patterned and may specifically include, without limitation, one or more rectangular, semicircular, or zig-zag longitudinal channels positioned generally parallel to a central axis of the massage roller core and generally spanning the width thereof. The channels may also include one or more transverse channels formed generally parallel to distal ends of the massage roller core and/or the longitudinal channels (in embodiments that include both the longitudinal channels and the transverse channels). Alternatively or in addition to, the channels may also include one or more alternating partial axial channels formed along the length, e.g., between each of the transverse channels. Moreover, the cutouts may more specifically include one or more oblong, rectangular, and/or triangular cutouts and the notches may include edge notches formed from one or more of the distal ends of the massage roller core. Of course, the channels, cutouts, and notches may not be limited to any particular number, shape, or size, and may be mixed and/or matched as needed or desired.

The channels, cutouts, and/or notches effectively reduce the mass of the massager roller core by eliminating material therefrom, thereby de facto reducing the mass of the massage roller and the related material and manufacturing costs. Moreover, given that the channels, cutouts, and/or notches do not leave an entire internal void (as in prior art hollow massage rollers), the massage rollers as disclosed herein remain structurally as sound as a solid core massage roller, yet saving mass and production costs.

The overlay may be compression heat wrapped to the outside of the massage roller core. In embodiments wherein the stock overlay material is relatively longer than the massage roller core, annular flaps may be folded over the distal ends of the massage roller core to generally lock the massage roller core inside the overlay and to conceal any of the channels, cutouts and/or notches that may be visible from (e.g., formed into) the distal ends. The annular flaps may be made from a relatively flexible or rigid material, and may be the same material as the massage protrusions extending out from the overlay. An adhesive dispensed between an inner surface of the overlay and an outer surface of the massage roller core may also help attach the overlay to the massage roller core.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of one embodiment of a massage roller having an overlay with annular flaps generally enclosing one embodiment of a massage roller core as disclosed herein;

FIG. 2 is a partial cut-away perspective view of the massage roller of FIG. 1, further illustrating the massage roller core having a longitudinal channel and a pair of transverse channels generally formed therein and otherwise typically hidden underneath the overlay;

FIG. 3 is a perspective view of another embodiment of a massage roller having an alternative core with four of the longitudinal channels viewable when used with an overlay without the annular flaps illustrated in FIGS. 1 and 2;

FIG. 4 is a partial cut-away perspective view of the massage roller of FIG. 3, further illustrating intersection of the longitudinal channels and the transverse channels typically hidden underneath the overlay;

FIG. 5 is a perspective view of another embodiment of a massage roller core as disclosed herein, including a pair of generally parallel transverse channels;

FIG. 6 is a perspective view of another embodiment of a massage roller core as disclosed herein, including a single longitudinal channel and a pair of transverse channels;

FIG. 7 is a perspective view of another embodiment of a massage roller core as disclosed herein, including four of the longitudinal channels positioned equidistantly about a circumference thereof and a pair of the transverse channels;

FIG. 8 is a perspective view of another embodiment of a massage roller core as disclosed herein, including three of the longitudinal channels positioned equidistantly about the circumference thereof and a pair of the transverse channels;

FIG. 9 is a perspective view of another embodiment of a massage roller core as disclosed herein, including six of the longitudinal channels positioned equidistantly about the circumference thereof and a pair of the transverse channels;

FIG. 10 is a perspective view of another embodiment of a massage roller core as disclosed herein, including a set of alternating partial axial channels intersecting the pair of transverse channels;

FIG. 11 is a perspective view of another embodiment of a massage roller core as disclosed herein, including four semicircular longitudinal channels;

FIG. 12 is a perspective view of another embodiment of a massage roller core as disclosed herein, including a pair of zig-zag longitudinal channels non-equidistantly located about the circumference thereof;

FIG. 13 is a perspective view of another embodiment of a massage roller core as disclosed herein, including a series of oblong cutouts distributed along an outer surface thereof;

FIG. 14 is a perspective view of another embodiment of a massage roller core as disclosed herein, including a series of rectangular cutouts distributed along the outer surface;

FIG. 15 is a perspective view of another embodiment of a massage roller core as disclosed herein, including a series of triangular cutouts distributed along the outer surface;

FIG. 16 is a perspective view of another embodiment of a massage roller core as disclosed herein, including a set of edge notches formed in distal ends thereof; and

FIG. 17 is an end view of another embodiment of a massage roller core as disclosed herein, including a pair of longitudinal channels extending a width thereof.

### DETAILED DESCRIPTION OF THE PREFERRED EMBODIMENTS

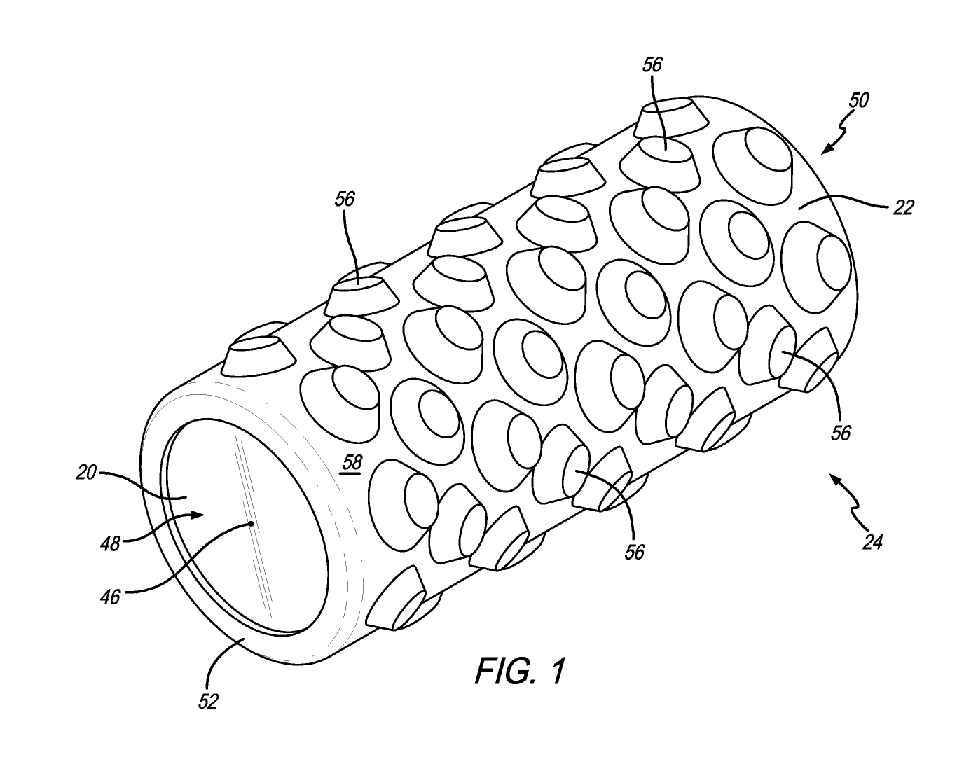

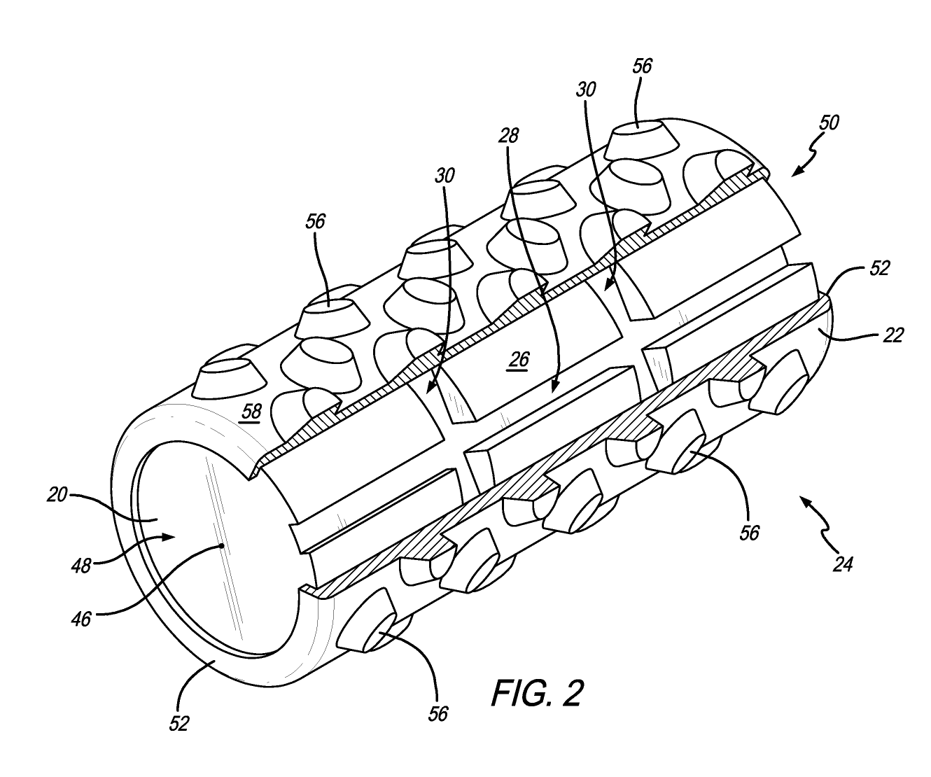

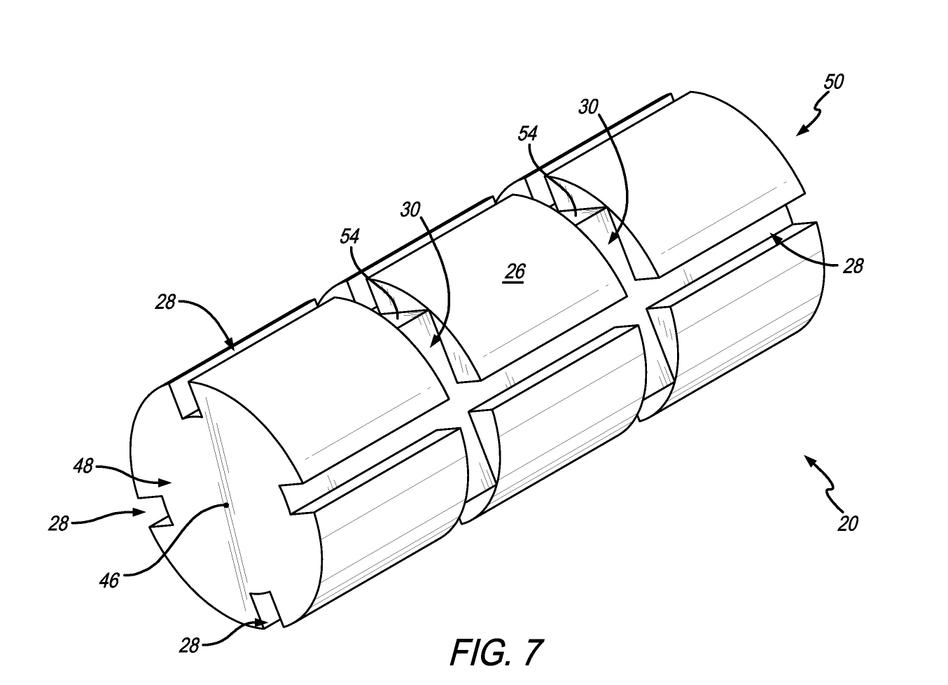

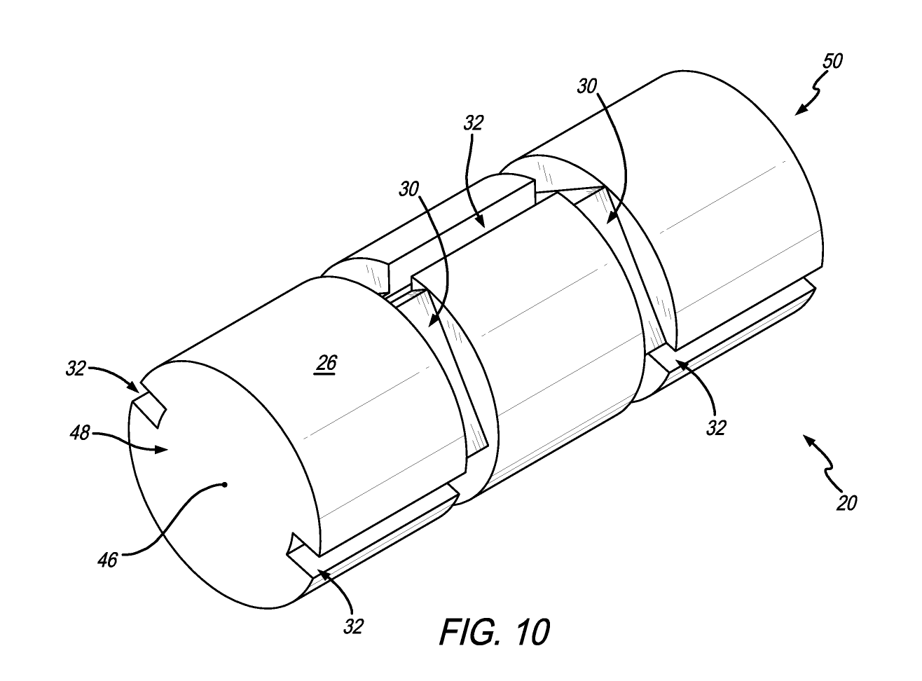

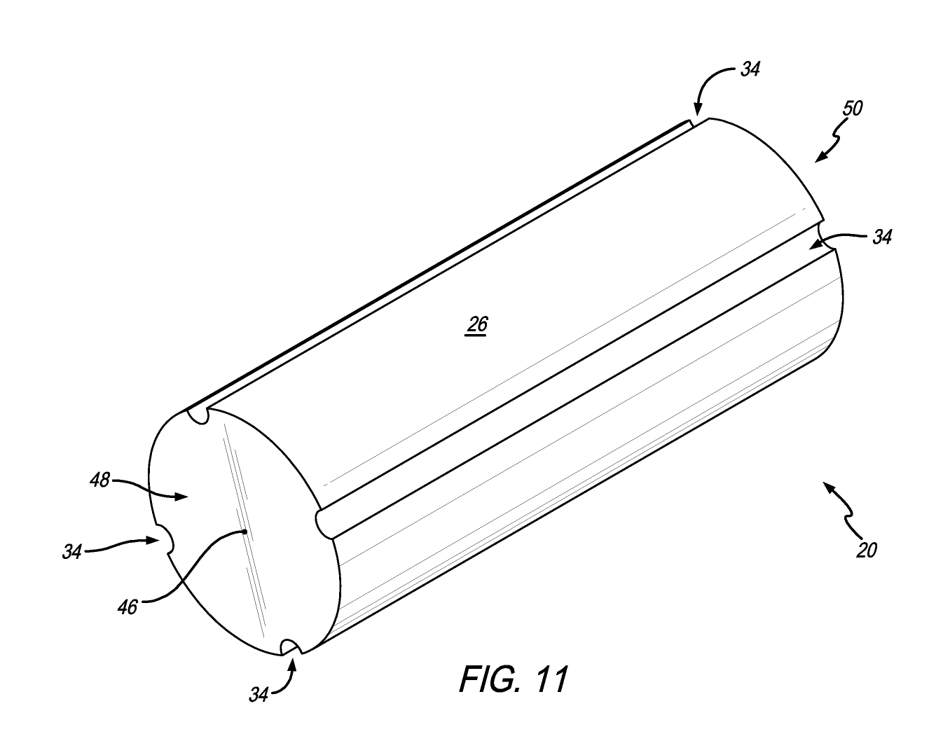

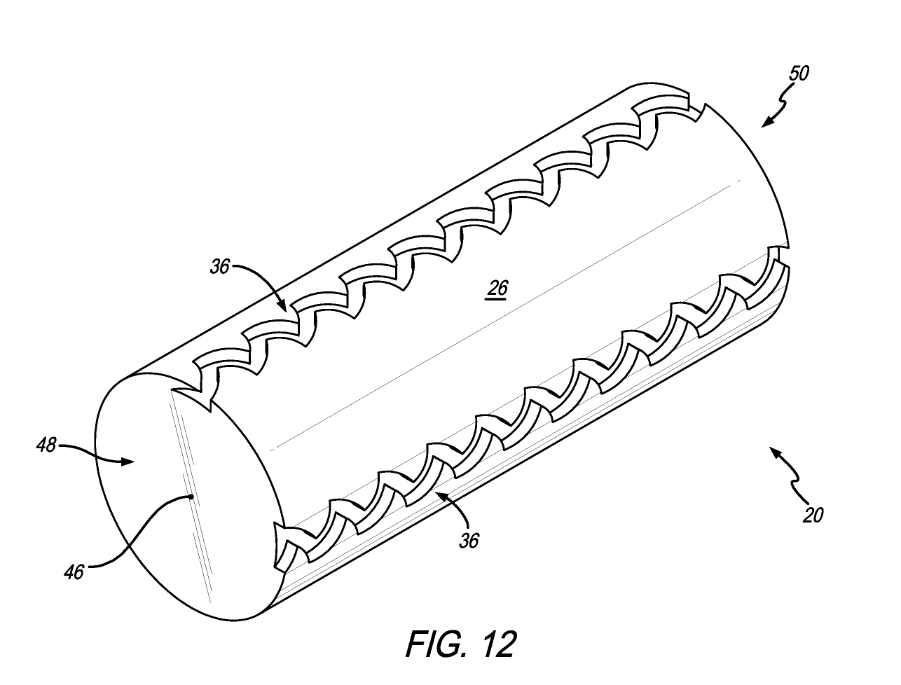

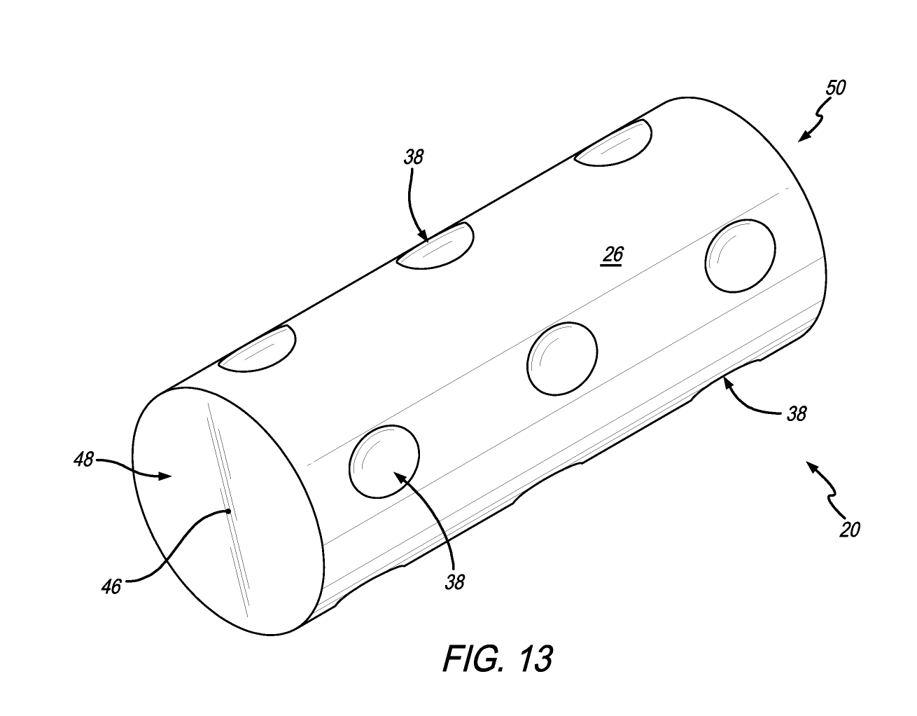

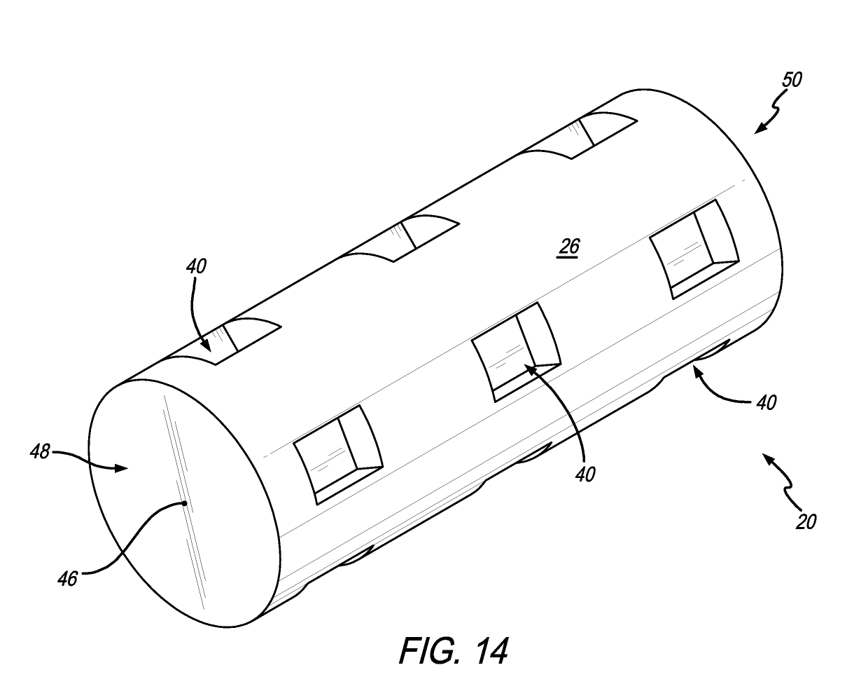

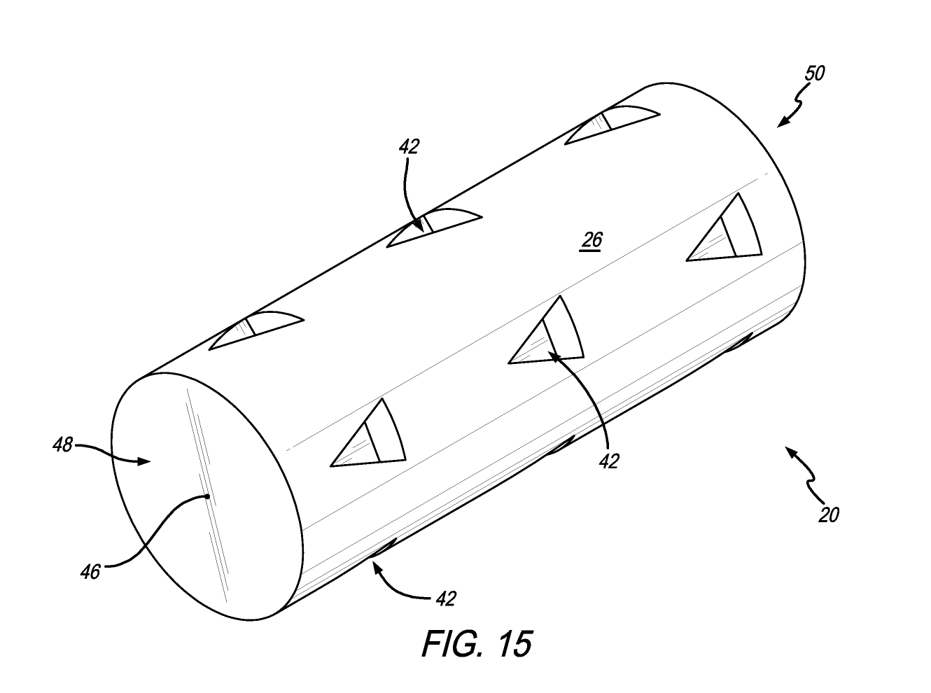

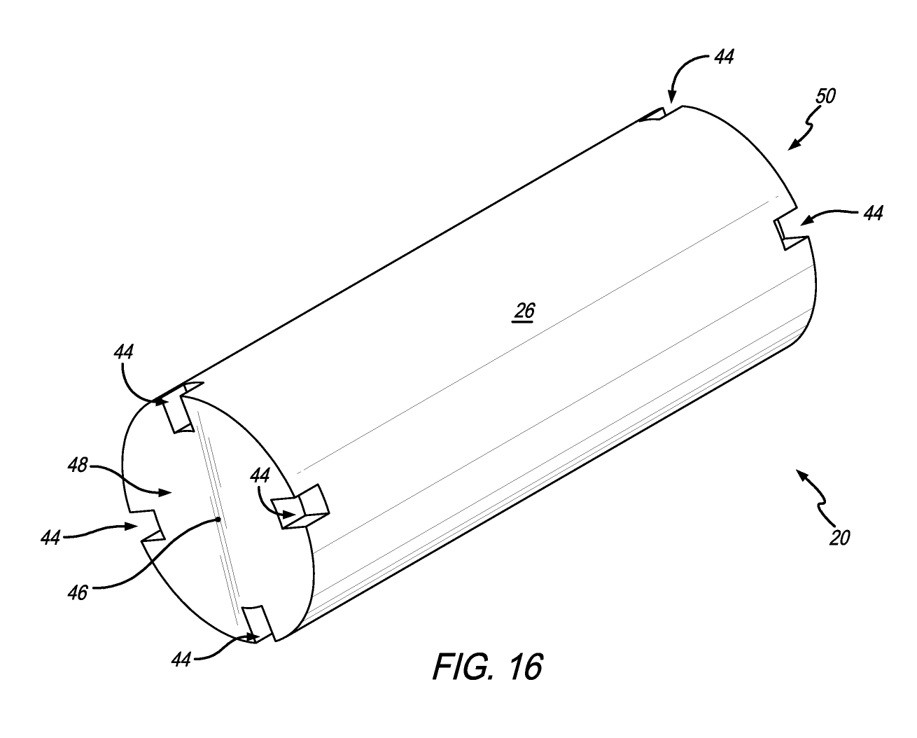

As shown in the exemplary drawings for purposes of illustration, various embodiments of a massage roller core as disclosed herein are referenced with respect to numeral 20 in FIGS. 1-17. As illustrated in FIGS. 1-4, the massage roller core 20 may be used with an overlay 22, as may be known in the art, to form a massage roller 24 having a relatively lighter weight construction than prior art solid core massage rollers or hollow massage rollers that incorporate a relatively hard or reinforced support cylinder (e.g., made from PVC) that provides compensated support for the overlay. More specifically, the massage roller core 20 may have a generally cylindrical cross-section (e.g., as substantially shown in FIG. 1 7) with an outer curved surface 26 (FIGS. 2 and 4-17). The outer curved surface 26 may have one or more channels, cutouts, or notches formed therein to reduce the mass of the massage roller core 20, such as one or more generally rectangular longitudinal channels 28 (FIGS. 2-4, 6-9 and 17), one or more transverse channels 30 (FIGS. 2 and 4-10), one or more alternating partial axial channels 32 (FIG. 10), one or more semicircular longitudinal channels 34 (FIG. 11), one or more zig-zag longitudinal (or partially longitudinal) channels 36 (FIG. 12), one or more oblong cutouts 38 (FIG. 13), one or more generally square or rectangular cutouts 40 (FIG. 14), one or more triangular cutouts 42 (FIG. 15), and/or one or more edge notches 44 (FIG. 16). Each of the channels 28, 30, 32, 34, 36, the cutouts 38, 40, 42, and/or the notches 44 may reduce the mass of the massage roller core 20, thereby also reducing its weight, production and transportation costs, etc. while simultaneously maintaining the structural integrity of the massage roller 24 such that the overlay 22 may continue to effectively apply compression forces to fascia to attain the desired myofacial release. Thus, the massage rollers 24 as disclosed herein, or other massage rollers as may be known in the art, incorporating any one of the various massage roller cores 20 may preserve core strength near a central axis 46 of the massage roller without the need for hard reinforcing materials such as PVC to achieve the advantages related to weight and production cost relative to other solid core or hollow reinforced massage rollers known in the art.

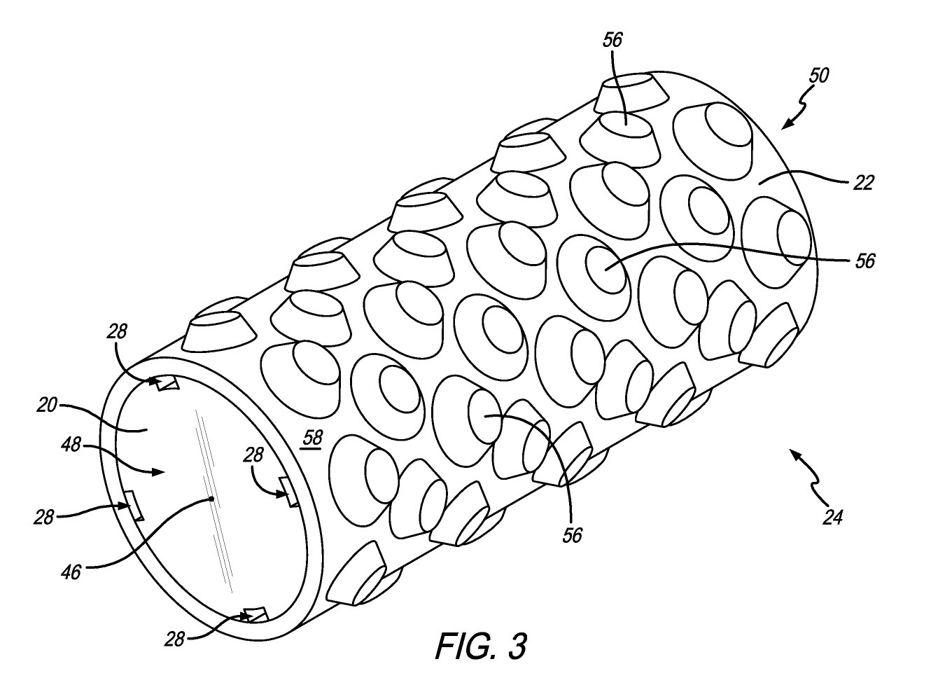

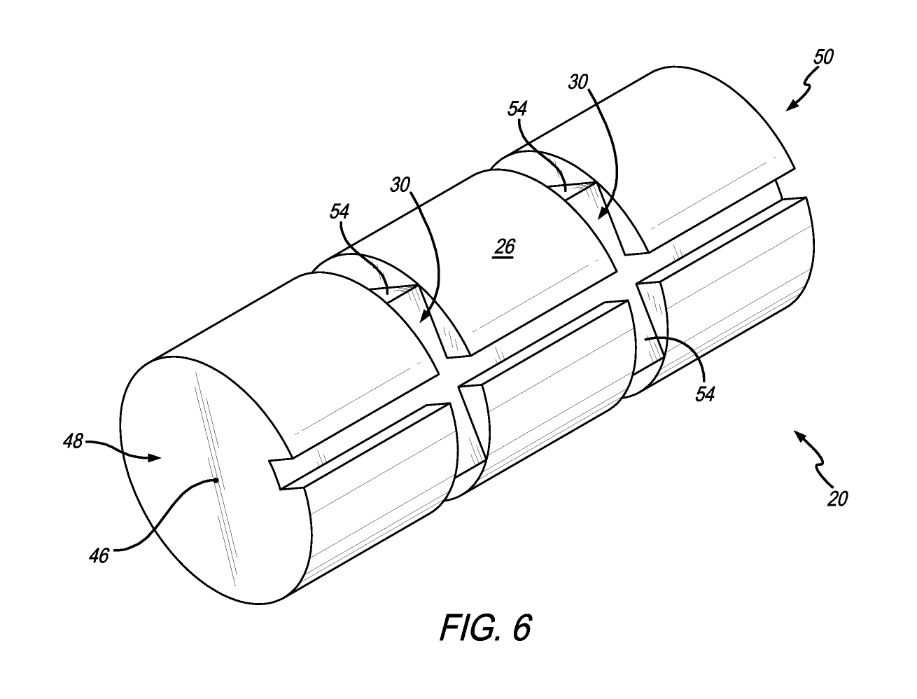

More specifically with respect to FIGS. 2-4, 6-9, 11-12, and 17, the massage roller core 20 may include one (e.g., illustrated in FIGS. 2 and 6) or more (e.g., as illustrated in FIGS. 3-4, 7-9, 11-12, and 17) of the channels 28, 30, 32, 34, 36. Each of the channels 28, 30, 32, 34, 36 may be formed from the cylindrical outer curved surface 26 and may run generally parallel to the central axis 46 of the massage roller core 20 from a first end 48 to a second end 50. In some embodiments as illustrated in FIG. 3, the channels 28, 30, 32, 34, 36 may be visible out from the first end 48 and/or the second end 50, depending whether the overlay 22 includes one or more annular flaps 52 (FIGS. 1-2) that generally extend over and partially enclose one or both of the first or second ends 48, 50 to hide one or more of the channels 28, 30, 32, 34, 36 thereunder.

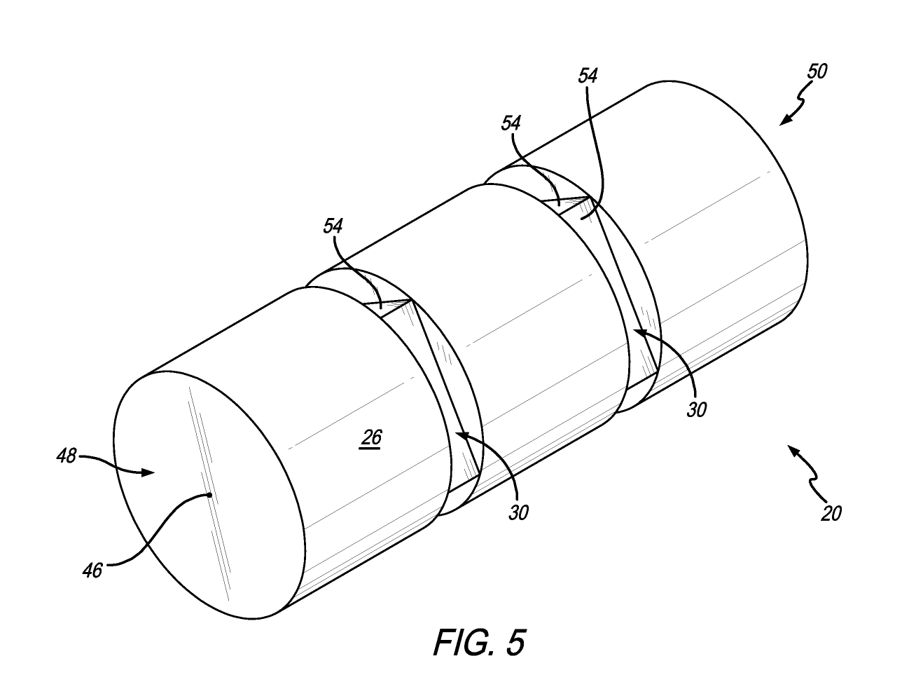

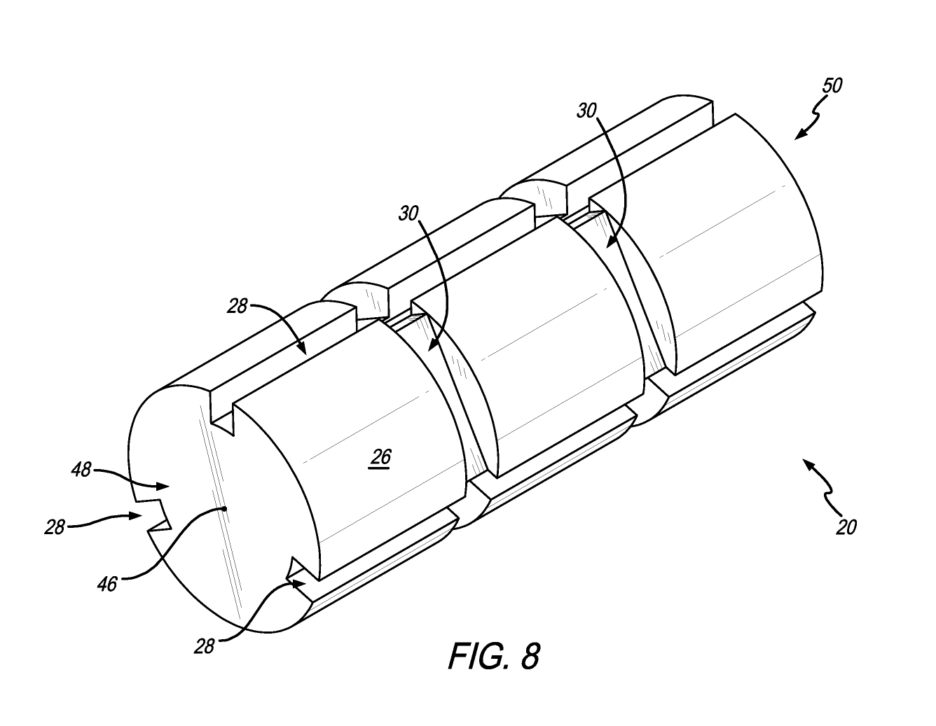

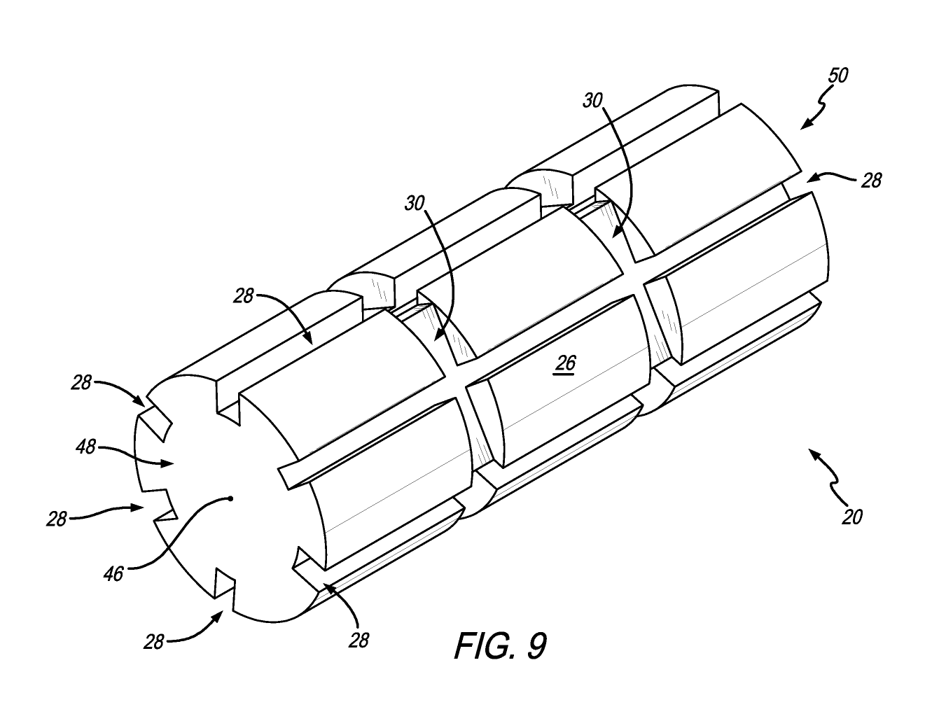

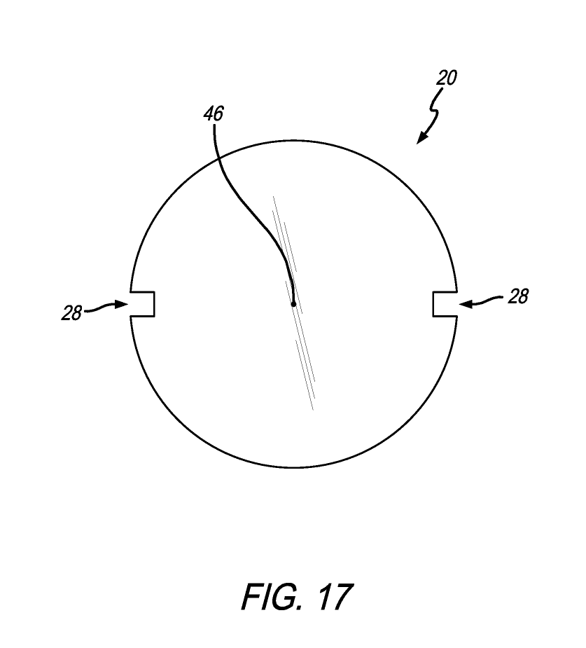

In one embodiment, the massage roller core 20 may include just one of the channels 28, 30, 32, 34, 36, as illustrated in FIGS. 2 and 6, while in other embodiments, the massage roller core 20 may include multiple of the channels 28, 30, 32, 34, 36. For example, FIG. 17 illustrates two of the rectangular longitudinal channels 28 approximately equidistantly positioned at 180 degree intervals relative to one another about the generally cylindrically-shaped massage roller core 20; FIG. 12 illustrates two of the zig-zag longitudinal channels 36 non-equidistantly positioned at less than 180 degree intervals relative to one another about the generally cylindrically-shaped massage roller core 20; FIG. 8 illustrates three of the rectangular longitudinal channels 28 approximately equidistantly positioned at 120 degree intervals relative to one another about the generally cylindrically-shaped massage roller core 20; FIGS. 3, 4, and 7 illustrate four of the rectangular longitudinal channels 28 approximately equidistantly positioned at 90 degree intervals relative to one another about the generally cylindrically-shaped massage roller core 20; and FIG. 9 illustrates six of the rectangular longitudinal channels 28 approximately equidistantly positioned at 60 degree intervals relative to one another about the generally cylindrically-shaped massage roller core 20. Although, of course, a person of ordinary skill in the art will recognize that the massage roller core 20 may include virtually any number of the channels 28, 30, 32, 34, 36, depending on the size of the channels 28, 30, 32, 34, 36, the size of the diameter of the massage roller core 20, and the desired structural integrity of the outer curved surface 26 supporting the overlay 22. For example, in embodiments wherein the overlay 22 is made from a relatively elastic or deformable material, it may be desired to have fewer of the channels 28, 30, 32, 34, 36, whereas when the overlay 22 is made from a relatively rigid and non-deformable material, the massage roller core 20 may include more (or larger) of the channels 28, 30, 32, 34, 36. Additionally, each of the channels 28, 30, 32, 34, 36 may be positioned relatively equidistantly (FIGS. 2-4, 6-9, 11, and 17) or non-equidistantly (FIG. 12) relative to one another about the cylindrical core 20. Of course, the massage roller core 20 does not necessarily need to include any of the longitudinal or axial channels 28, 32, 34, 36, 38 as illustrated, e.g., in FIG. 5, or may not include any of the channels 28, 30, 32, 34, 36 at all (e.g., as illustrated in FIGS. 13-16).

In an alternative embodiment, the massage roller core 20 may include the alternating partial axial channels 32 as illustrated in FIG. 10. Here, the alternating partial axial channels 32 may span a portion of the axial length of the massage roller core 22, such as between one of the first or second ends 48, 50 of the massage roller core 20 and a transverse channel 30 or between two of the traverse channels 30 when the massage roller core 20 includes multiple of the transverse channels 30. Furthermore, the alternating partial axial channels 32 may be positioned in axial misalignment relative to one another along the circumference of the outer curved surface 26 as illustrated in FIG. 10.

As illustrated in FIGS. 2-4, 6-9, and 17, the rectangular longitudinal channel 28 may have a generally square or rectangular cross-section that extends the width of the massage roller core 20. Although, of course, the geometry of the channel could vary in size and shape. For example, in other embodiments disclosed herein, FIG. 11 illustrates an embodiment wherein the massage roller 20 includes a plurality of the semicircular longitudinal channels 34 and FIG. 12 illustrates the zig-zag longitudinal channels 36. Of course, the channels may include other sizes and/or shapes, depending on the desired mass and rolling characteristics of the massage roller 24. For example, increasing the width of the cross-sections of the channels 28, 30, 32, 34, 36 (e.g., the chord between two distal ends of the perimeter of a given channel from a series of the channels 28, 30, 32, 34, 36) increases the width of the channels 28, 30, 32, 34, 36 such that the channels 28, 30, 32, 34, 36 become wider, thereby decreasing the mass of the massage roller 20, and vice versa. Of course, wider channels 28, 30, 32, 34, 36 may require the use of a more structurally reinforced or rigid overlay 22 to provide maximum rolling engagement with the body fascia. In a similar sense, increasing the depth of the channels 28, 30, 32, 34, 36 (e.g., the dimension of the cross-section of a given channel 28, 30, 32, 34, 36 extending generally in a radial direction relative to the central axis 46) decreases the amount of interior material within the massage roller core 20, thereby decreasing the mass of the massage roller core 20, and vice versa. Additionally, each of the channels 28, 30, 32, 34, 36 may vary in height and/or width from one another and/or each of the channels 28, 30, 32, 34, 36 may intermix with one another in a single massage roller core 20. Furthermore, the cross-section of any of the channels 28, 30, 32, 34, 36 may, but need not be, uniform in shape (e.g., length, width, and/or height) throughout each of the channels 28, 30, 32, 34, 36.

The channels 28, 30, 32, 34, 36 also need not run parallel to the central axis of the massage roller core 20 and/or in the same direction at all points along the axial length of the massage roller core 20. In this respect, in one embodiment, the channels may include the zig-zag longitudinal channels 36 as illustrated in FIG. 12. Of course, the channels 28, 30, 32, 34, 36 could also curve or bend in other directions (e.g., patterned, uniform, or otherwise) along the axial length or width of the massage roller core 20, such as in a spiral.

In addition to or instead of the series of longitudinal channels 28, 34, 36, the massage roller core 20 may include one or more of the transverse channels 30 positioned along the axial length of the massage roller core 20. For example, in one embodiment, each of the transverse channels 30 may be positioned generally parallel to the first and second ends 48, 50 of the massage roller core 20, as shown best in FIGS. 2 and 4-10. While FIGS. 2 and 4-10 illustrate two of the transverse channels 30, the number of the transverse channels 30 may vary from as few as no transverse channel 30 (e.g., as illustrated in FIGS. 11-16) to as many as the massage roller core 20 will accommodate, depending on the size of the massage roller core 20 (e.g., its length and diameter) and the size/shape of the transverse channels 30. For example, the massage roller core 20 may accommodate a larger number of narrower and/or shallower transverse channels 30, and vice versa.

The transverse channels 30 are illustrated in FIGS. 2 and 4-10 having a generally rectangular cross-section, similar to the rectangular longitudinal channels 28 disclosed herein. Although, of course, the cross-section of the transverse channels 30 may vary in shape and size. For example, in one embodiment, the transverse channels may take on the size, shape, and/or construction of the semicircular longitudinal channels 34 and/or the zig-zag longitudinal channels 36, as disclosed herein, except they may be generally parallel to the first and second ends 48,50 as opposed to perpendicular thereof. The transverse channels 30 may also include other shapes and/or sizes and should not be limited to rectangular, semicircular, and/or zig-zag patterns.

Additionally, the transverse channels 30 may partially or completely circumscribe the central axis 46 of the massage roller 24. For example, in the embodiments disclosed herein, the transverse channels 30 may completely circumscribe the central axis 46 to form a generally rectangular core 54 (e.g., as illustrated in FIGS. 5-7) having a cross-section generally smaller than the cross-section of the outer curved surface of 26 of the massage roller core 20. In one embodiment, the rectangular core 54 formed by the circumscribing transverse channels 30 may extend substantially between the first and second ends 48, 50. Here, the massage roller core 20 may support the overlay 22 at or near each of the first and second ends 48, 50 by a relatively smaller width outer curved surface 26. In other embodiments, three of the transverse channels 30 may form a triangular core, five of the transverse channels 30 may form a pentagonal core, six of the transverse channels 30 may form a hexagonal core, etc. In alternative embodiments, the transverse channels 30 may be formed in less than the entire cross-section of the outer curved surface 26 of the massage roller core 20. In these embodiments, the transverse channels 30 may not form the rectangular core 54 (or other polygonal core), but rather a portion thereof (e.g., one, two, or three sides thereof). In another alternative embodiment, the transverse channels 30 may be formed at intervals staggered from one another.

In another alternative embodiment (not shown), the massage roller core 20 may include a channel or cutout generally in the shape of a swirl that extends circumferentially around the outer curved surface 26 and generally extends a width of the massage roller core 20.

In addition to or instead of any of the channels 28, 30, 32, 34, 36, the massage roller core 20 may include one or more of the cutouts 38, 40, 42 distributed along the outer curved surface 26 of the massage roller core 20. The cutouts 38, 40, 42 may be virtually any shape or size, including, but not limited to, the oblong cutouts 38 illustrated in FIG. 13, the rectangular cutouts 40 illustrated in FIG. 14, and/or the triangular cutouts 42 illustrated in FIG. 15. The cutouts 38, 40, 42 may vary in size, shape, and/or construction, and/or the cutouts 38, 40, 42 may be mixed and/or matched as desired, including with any of the channels 28, 30, 32, 34, 36 and/or the notches 44, as disclosed herein. Similarly, the cutouts 38, 40, 42 may decrease the mass of the massage roller core 20 in addition to or instead of any one of the channels 28, 30, 32, 34, 36 and/or the edge notches 44.

In addition to or instead of any of the channels 28, 30, 32, 34, 36 and/or the cutouts 38, 40, 42, the massage roller core 20 may include one or more of the edge notches 44 as illustrated in FIG. 16. Here, the edge notches 44 may be formed from one or more of the first or second ends 48, 50 of the massage roller core 20 and/or the outer curved surface 26 as shown. FIG. 16 illustrates one embodiment wherein each of the first and second ends 48, 50 include four of the edge notches 44 equidistantly positioned at approximately 90 degree intervals relative to one another (although two of the edge notches 44 on the end 50 are hidden from view). In alternative embodiments, each of the first and second ends 48, 50 may include none of the edge notches 44 or as many of the edge notches 44 as practically possible to still envelop the massage roller core 20 within the overlay 22 for use as the massage roller 24. In this respect, increasing the diameter of the massage roller core 20 and/or decreasing the width of the edge notches 44 may permit inclusion of an increased number of the edge notches 44 in the massage roller core 20, and vice versa. Additionally, the edge notches 44 may be square as shown in FIG. 16, or may alternatively be rectangular (e.g., having a larger width or depth relative to the other), or may be a another shape (e.g., circular, polygonal, etc.). Of course, as with the other embodiments disclosed above, the edge notches 44 may be equidistantly or non-equidistantly positioned around the circumference of the outer curved surface 26.

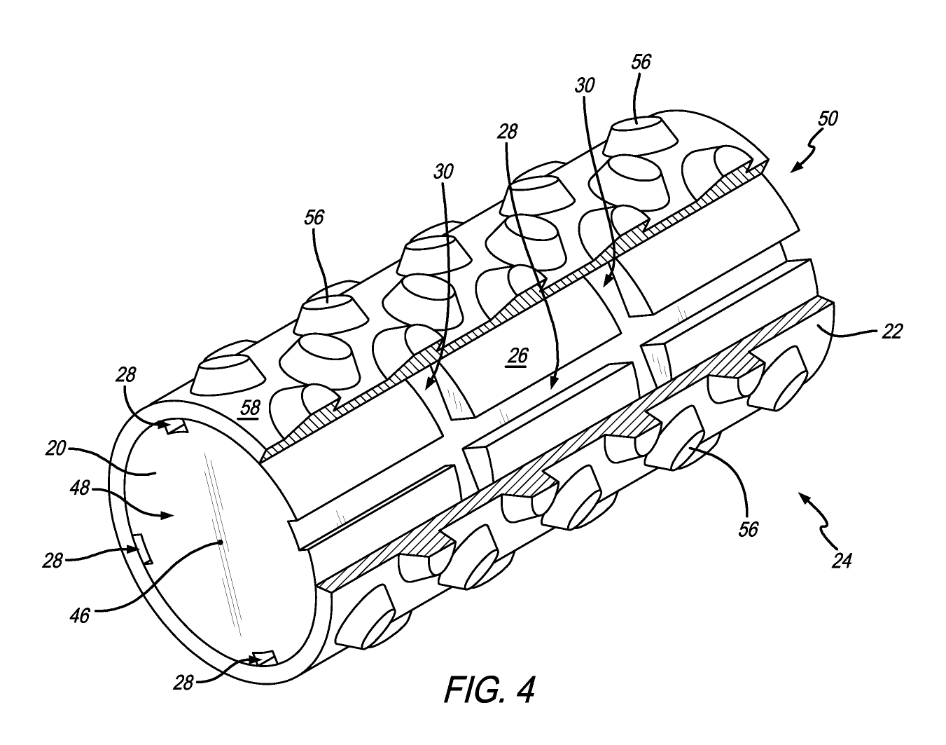

The overlay 22 may be designed to permanently attach to the massage roller core 20 (e.g., with an additional adhesive dispensed between an inner surface of the overlay and an outer surface of the massage roller core to help attach the overlay 22 to the massage roller core 20) and/or the overlay 22 may be selectively attachable and/or selectively removable from the massage roller core 20. In the latter embodiment, it may be possible to interchange different types of the massage roller cores 20 for use with different overlays 22, depending on the desired use, mass, and structural integrity of the overall massage roller 24. In this respect, the overlay 22 may have the shape of a generally hollow cylinder with an inner diameter designed to be positioned flush against an outer diameter of the massage roller core 20, so the outer curved surface 26 of the massage roller core 20 abuts the relatively round inner surface of the overlay 22. As illustrated in FIG. 2, the overlay 22 may include the annular flaps 52 at one or more of the first or second ends 48, 50 to more snugly attach the overlay 22 to the massage roller core 20 and to hide one or more of the channels 28, 30, 32, 34, 36 and/or the cutouts 38, 40, 42 formed therein. The annular flaps 52 may have an inner diameter relatively narrower than the diameter of the massage roller core 20 to generally prevent the massage roller core 20 from sliding out from within the overlay 22 once wrapped therein. In an alternative embodiment, the overlay 22 may be made of a flexible material that permits deforming the annular flaps 52 to allow the massage roller core 20 to be inserted into and/or removed from the overlay 22. The overlay 22 may also be made from an elastic material so the annular flaps 52 may return to their original size and/or shape after insertion and/or removal of the massage roller core 20. The adhesive may also further ensure attachment to the outer curved surface 26 of the massage roller 20, and may help prevent slide-out removal of the massage roller core 20 when the overlay 22 does not include the annular flaps 52. This may be beneficial in embodiments wherein the massage roller core 20 is not designed to be interchanged with the overlay 22, such as illustrated with respect to the embodiment shown in FIGS. 3 and 4,.

An adhesive may fill one or more of the channels 28, 30, 32, 34, 36, the cutouts 38, 40, 42, and/or the notches 44 to help attach the overlay 22 to the massage roller core 20. In these embodiments, the adhesive may be generally of lighter weight than the massage roller core 20 to maintain a relatively lightweight design.

The overlay 22 may also include a series of projections 56 distributed along and protruding outwardly from an outer surface 58. As illustrated in FIGS. 1-4, the projections 56 may be shaped generally as conical frustums, although the projections 56 may be of virtually any size or shape such as cylindrical, rectangular prismatic, triangular prismatic, or any other shape desired to maximize myofascial release.

Although several embodiments have been described in detail for purposes of illustration, various modifications may be made without departing from the scope and spirit of the invention. Accordingly, the invention is not to be limited, except as by the appended claims.

What is claimed is:

1. A massage roller, comprising:
a generally cylindrically-shaped core having a central axis;
an overlay formed around an outer surface of the cylindrically-shaped core and having a size and shape to facilitate rolling engagement with myofascial tissue; and
at least one cavity formed from the outer surface of the cylindrically-shaped core that reduces a mass of the massage roller while the massage roller simultaneously maintains substantially the same structural rigidity for rolling engagement with myofascial tissue.

2. The massage roller of claim 1, wherein the cavity comprises a straight channel, a curved channel, a patterned channel, or a spiral channel.

3. The massage roller of claim 1, wherein the cavity comprises a longitudinal channel generally parallel to the central axis and extending a length of the cylindrically-shaped core.

4. The massage roller of claim 3, wherein the longitudinal channel comprises a rectangular shape, a semicircular shape, or a zig-zag shape.

5. The massage roller of claim 3, wherein the longitudinal channel comprises multiple longitudinal channels positioned approximately equidistantly from one another about a circumference of the cylindrically-shaped core.

6. The massage roller of claim 1, wherein the cavity comprises at least one transverse channel formed generally perpendicular to the central axis.

7. The massage roller of claim 6, including a longitudinal channel positioned perpendicular to and intersecting the at least one transverse channel.

8. The massage roller of claim 6, wherein the at least one transverse channel comprises four linearly aligned transverse channels together circumscribing the central axis of the cylindrically-shaped core, thereby forming a rectangular-shaped cut-out.

9. The massage roller of claim 8, wherein the rectangular-shaped cut-out comprises a width greater than 50% of the width of the cylindrically-shaped core, the overlay being supported by the outer surface at opposite ends of the cylindrically-shaped core.

10. The massage roller of claim 6, wherein the at least one transverse channel comprises at least three linearly aligned transverse channels together circumscribing the central axis of the cylindrically-shaped core, thereby forming a polygonal-shaped cut-out.

11. The massage roller of claim 10, wherein the polygonal-shaped cut-out comprises a triangular-shaped cut-out, a pentagonal-shaped cut-out, or a hexagonal-shaped cut-out.

12. The massage roller of claim 1, wherein the cavity comprises a set of alternating partial axial channels positioned along a length of the cylindrically-shaped core, each of the set of alternating partial axial channels having a length relatively smaller than a length of the cylindrically-shaped core.

13. The massage roller of claim 12, wherein at least two of the set of alternating partial axial channels are in misalignment with one another.

14. The massage roller of claim 12, wherein at least one of the alternating partial axial channels intersects at least one transverse channel.

15. The massage roller of claim 1, wherein the cavity comprises an oblong cutout, a rectangular cutout, or a triangular cutout.

16. The massage roller of claim 1, wherein the cavity comprises an edge notch formed from at least one end of the cylindrically-shaped core.

17. The massage roller of claim 16, wherein the edge notch is externally visible when the overlay is positioned over the outer surface of the cylindrically-shaped core.

18. The massage roller of claim 16, wherein the overlay includes an annular edge flap having a diameter relatively smaller than a major diameter of the cylindrically-shaped core, the annular edge flap being positioned to generally envelope the edge notch and lock the cylindrically-shaped core within the overlay.

19. The massage roller of claim 18, wherein the overlay comprises an elastic material permitting temporary deformation of the annular edge flap to insert or remove the cylindrically-shaped core.

20. The massage roller of claim 1, wherein each end of the cylindrically-shaped core includes a plurality of edge notches positioned at intervals equidistant relative to one another.

21. The massage roller of claim 1, wherein the cavity comprises multiple cavities positioned non-equidistantly relative to one another.

22. A massage roller, comprising:
a generally cylindrically-shaped core having a central axis;
an overlay formed around an outer surface of the cylindrically-shaped core and having a size and shape to facilitate rolling engagement with myofascial tissue; and
at least three linearly aligned transverse channels formed from the outer surface of the cylindrically-shaped core and generally perpendicular to the central axis together circumscribing the central axis to form a polygonal-shaped cut-out that reduces a mass of the massage roller while the massage roller simultaneously maintains substantially the same structural rigidity for rolling engagement with myofascial tissue.

23. The massage roller of claim 22, wherein the at least three linearly aligned transverse channels comprise four substantially equal sized linearly aligned transverse channels forming a rectangular-shaped cut-out having a width greater than 50% of the width of the cylindrically-shaped core.

24. The massage roller of claim 22, wherein the polygonal-shaped cut-out comprises a triangular-shaped cut-out, a pentagonal-shaped cut-out, or a hexagonal-shaped cut-out.

25. The massage roller of claim 22, including a longitudinal channel positioned perpendicular to and intersecting at least one of the at least three linearly aligned transverse channels.

26. The massage roller of claim 25, including multiple cavities formed in the outer surface and positioned non-equidistantly relative to one another, wherein the longitudinal channel extends a length of the cylindrically-shaped core.

27. The massage roller of claim 22, including a set of alternating partial axial channels formed into the outer surface of the cylindrically-shaped core and having a length relatively shorter than a length of the cylindrically-shaped core, wherein at least one of the alternating partial axial channels intersects at least one of the at least three linearly aligned transverse channels.

28. The massage roller of claim 27, wherein at least two of the set of alternating partial axial channels are in misalignment with one another and the outer surface includes at least one of an oblong cutout, a rectangular cutout, or a triangular cutout.

29. A massage roller, comprising:
a generally cylindrically-shaped core having a central axis;
an overlay formed around an outer surface of the cylindrically-shaped core and having a size and shape to facilitate rolling engagement with myofascial tissue;
at least one edge notch formed from at least one end of the cylindrically-shaped core that reduces a mass of the massage roller while the massage roller simultaneously maintains substantially the same structural rigidity for rolling engagement with myofascial tissue; and
an annular edge flap having a diameter relatively smaller than a major diameter of the cylindrically-shaped core and being positioned to generally envelope the edge notch and lock the cylindrically-shaped core within the overlay.

30. The massage roller of claim 29, wherein the annular edge flap comprises an elastic material permitting temporary deformation thereof to insert or remove the cylindrically-shaped core and each end of the cylindrically-shaped core includes a plurality of edge notches positioned at equidistant intervals relative to one another.

31. The massage roller of claim 29, including multiple cavities formed into the outer surface of the cylindrically-shaped core and positioned non-equidistantly relative to one another.

32. The massage roller of claim 31, wherein the multiple cavities comprise oblong cutouts, rectangular cutouts, or triangular cutouts.

33. The massage roller of claim 29, including a set of alternating partial axial channels positioned along a length of the cylindrically-shaped core, each of the set of alternating partial axial channels having a length relatively smaller than a length of the cylindrically-shaped core.

34. The massage roller of claim 33, wherein at least two of the set of alternating partial axial channels are in misalignment with one another and at least one of the alternating partial axial channels intersects at least one transverse channel formed into the outer surface of the cylindrically-shaped core.

35. A massage roller, comprising:
a generally cylindrically-shaped core having a central axis;
an overlay formed around an outer surface of the cylindrically-shaped core and having a size and shape to facilitate rolling engagement with myofascial tissue;
at least one transverse channel formed generally perpendicular to the central axis;
at least one longitudinal channel generally parallel to the central axis and extending a length of the cylindrically-shaped core and intersecting the at least one transverse channel;
a set of alternating partial axial channels positioned along a length of the cylindrically-shaped core, each having a length relatively shorter than a length of the cylindrically-shaped core; and
an edge notch formed from at least one end of the cylindrically-shaped core;
wherein each of the at least one transverse channel, the at least one longitudinal channel, the set of alternating partial axial channels, and the edge notch cooperate to reduce a mass of the massage roller while the massage roller simultaneously maintains substantially the same structural rigidity for rolling engagement with myofascial tissue.

36. The massage roller of claim 35, wherein the longitudinal channel comprises multiple longitudinal channels positioned approximately equidistantly from one another about a circumference of the cylindrically-shaped core.

37. The massage roller of claim 36, wherein the multiple longitudinal channels comprise straight channels, curved channels, patterned channels, spiral channels, rectangular channels, semicircular channels, or zig-zag channels.

38. The massage roller of claim 35, wherein the at least one transverse channel comprises at least three linearly aligned transverse channels together circumscribing the central axis of the cylindrically-shaped core, forming a polygonal-shaped cut-out having a width greater than 50% of the width of the cylindrically-shaped core such that the overlay is supported by the outer surface at opposite ends of the cylindrically-shaped core.

39. The massage roller of claim 35, including a cavity comprising an oblong cutout, a rectangular cutout, or a triangular cutout, wherein the edge notch is externally visible when the overlay is positioned over the outer surface of the cylindrically-shaped core.

40. The massage roller of claim 35, wherein the overlay comprises an elastic material permitting temporary deformation of an annular edge flap having a diameter relatively smaller than a major diameter of the cylindrically-shaped core so that the annular edge flap can be stretched from a normal use position generally enveloping the edge notch and locking the cylindrically-shaped core within the overlay to an open position permitting insertion or removal of the cylindrically-shaped core, wherein each end of the cylindrically-shaped core includes a plurality of edge notches positioned at equidistant intervals relative to one another.
